(19) United States
(12) Patent Application Publication
(10) Pub. No.: US 2020/0151972 A1
(43) Pub. Date: May 14, 2020

(54) IN-VEHICLE AUTHENTICATION SYSTEM, VEHICLE COMMUNICATION APPARATUS, AUTHENTICATION MANAGEMENT APPARATUS, IN-VEHICLE AUTHENTICATION METHOD, AND COMPUTER READABLE MEDIUM

(71) Applicant: MITSUBISHI ELECTRIC CORPORATION, Tokyo (JP)

(72) Inventors: Junko NAKAJIMA, Tokyo (JP); Hirohito NISHIYAMA, Tokyo (JP); Ryo MURAMATSU, Tokyo (JP); Yuya TAKATSUKA, Tokyo (JP)

(73) Assignee: MITSUBISHI ELECTRIC CORPORATION, Tokyo (JP)

(21) Appl. No.: 16/604,032

(22) PCT Filed: May 9, 2017
(86) PCT No.: PCT/JP2017/017476

§ 371 Date: Oct. 9, 2019

(51) Int. Cl. G07C 5/08; B60R 16/023; G06F 16/23; G06F 16/9035

(52) U.S. Cl. CPC G07C 5/0816; G06F 16/9035; G06F 16/2358; B60R 16/0231

(57) ABSTRACT

An in-vehicle authentication system has a vehicle communication apparatus (100) that is provided in a vehicle equipped with a plurality of ECUs and that communicates with each ECU of the plurality of ECUs. An authentication part (101) performs configuration authentication for authenticating validity of a configuration for each ECU, and registers an ECU that has failed the configuration authentication in an authentication error list. A determination part (102) determines an in-vehicle function that is realizable in the vehicle based on the authentication error list and a function correlation table which indicates correlation between an in-vehicle function realized in the vehicle and an ECU used to realize the in-vehicle function. A display part (107) displays the in-vehicle function determined to be realizable in the vehicle by the determination part (102) on a display (805).

### TECHNICAL FIELD

The present invention relates to an in-vehicle authentication system, an in-vehicle authentication method, and an in-vehicle authentication program.

### BACKGROUND ART

In recent years, an in-vehicle system is equipped with many electric control units (ECUs) that control various functions. Each ECU is mutually connected with other ECUs via an in-vehicle network and performs coordinated operation with the other ECUs. Attacks by unauthorized manipulations have also become problematic, such as connecting an unauthorized device to the in-vehicle network or replacing an authorized device with an unauthorized device. Therefore, techniques to protect the in-vehicle system from such attacks are important. The techniques for protecting the in-vehicle system include techniques for preventing attacks in advance, and techniques for reducing the effects of unauthorized control when there is a high likelihood that a vehicle will be subjected to unauthorized control.

In order to equip the ECUs with techniques for protecting the in-vehicle system, software updates for changing functions and adding functions to the ECUs are becoming commonplace. Furthermore, support for Plug and Play (PnP) when a new ECU is added is also required. In order to implement them securely, it is necessary to perform authentication for distinguishing between unauthorized ECUs and authorized ECUs, and perform configuration authentication in a situation where changes in configuration may occur.

Furthermore, when a function is added to an ECU, a new in-vehicle function is provided to users. This causes a change in the correlation between the ECU and other ECUs that perform coordinated operation in the vehicle. Therefore, there is a need for an arrangement for managing the latest information according to the change.

Patent Literature 1 discloses a technique of providing a correspondence information table in which security levels associated with ECUs and fraud handling processes corresponding to the security levels are defined, and performing a fraud handling process corresponding to an ECU in which a fraud has been detected.

Patent Literature 2 describes a technique in which a master ECU has a database of information on all ECUs that may be installed in a vehicle, and the master ECU validates ECUs other than the master ECU, thereby performing configuration validation.

### CITATION LIST

### Patent Literature

Patent Literature 1: JP 2016-134170 A

Patent Literature 2: JP 2010-11400 A

### SUMMARY OF INVENTION

### Technical Problem

In the technique of Patent Literature 1, a fraud handling process such as “stop, slow down, travel at some distance, or notify” is only performed. Therefore, in the technique of Patent Literature 1, there is a risk of excessively stopping in-vehicle functions.

In the technique of Patent Literature 2, the disclosure includes only the technique up to disabling communication between an ECU concerned and other ECUs when configuration validation cannot be confirmed. Therefore, in the technique of Patent Literature 2, a driver cannot check the states of the vehicle's functions, so that safety and convenience are inferior.

It is an object of the present invention to, when an unauthorized ECU is detected, improve safety and convenience by displaying in-vehicle functions that can be realized by ECUs other than the unauthorized ECU.

### Solution to Problem

An in-vehicle authentication system according to the present invention has a vehicle communication apparatus, the vehicle communication apparatus being provided in a vehicle equipped with a plurality of electronic control units and communicating with each electronic control unit of the plurality of electronic control units, and the in-vehicle authentication system includes:

an authentication part to perform configuration authentication for authenticating validity of a configuration for each electronic control unit of the plurality of electronic control units, and register an electronic control unit that has failed the configuration authentication in an authentication error list;

a determination part to determine an in-vehicle function that is realizable in the vehicle based on the authentication error list and a function correlation table which indicates correlation between an in-vehicle function realized in the vehicle and an electronic control unit used to realize the in-vehicle function; and

a display part to display the in-vehicle function determined to be realizable in the vehicle by the determination part on a display of the vehicle communication apparatus.

### Advantageous Effects of Invention

In an in-vehicle authentication system according to the present invention, an authentication part registers an electronic control unit that has failed configuration authentication in an authentication error list. A determination part determines an in-vehicle function that is realizable in a vehicle based on the authentication error list and a function correlation table which indicates correlation between an in-vehicle function and an electronic control unit used to realize the in-vehicle function. A display part displays the in-vehicle function determined to be realizable in the vehicle on a display of a vehicle communication apparatus. Therefore, in the in-vehicle authentication system according to the present invention, safety and convenience can be improved without excessively stopping in-vehicle functions even when an unauthorized electronic control unit is detected.

### BRIEF DESCRIPTION OF DRAWINGS

FIG. 1 is a configuration diagram of an in-vehicle authentication system 10 according to a first embodiment;

FIG. 2 is a configuration diagram of a vehicle communication apparatus 100 according to the first embodiment;

FIG. 3 is a configuration diagram of a vehicle 200 according to the first embodiment;

FIG. 4 is a configuration diagram of an authentication management apparatus 300 according to the first embodiment;

FIG. 5 is an example illustrating details of an ECU information table 620 according to the first embodiment;

FIG. 6 is an example illustrating details of a configuration data table 610 according to the first embodiment;

FIG. 7 is an example illustrating details of a function correlation table 640 according to the first embodiment;

FIG. 8 is a flowchart of a function management process according to the first embodiment;

FIG. 9 is a flowchart of an authentication process according to the first embodiment;

FIG. 10 is a diagram illustrating an example of an authentication error list 630 according to the first embodiment;

FIG. 11 is a diagram illustrating an example of an authentication error table 631 according to the first embodiment;

FIG. 12 is a flowchart of details of a configuration authentication process according to the first embodiment;

FIG. 13 is a flowchart of a determination process according to the first embodiment;

FIG. 14 is a diagram illustrating a specific example of a function correlation table 640 according to the first embodiment;

FIG. 15 is a diagram illustrating a function display screen 500 according to the first embodiment;

FIG. 16 is a diagram illustrating a configuration of update information 650 according to the first embodiment;

FIG. 17 is a flowchart of an update process according to the first embodiment;

FIG. 18 is a flowchart of a software update process according to the first embodiment;

FIG. 19 is a flowchart of a table update process according to the first embodiment;

FIG. 20 is a configuration diagram of an auxiliary storage device 903 of the authentication management apparatus 300 according to the first embodiment;

FIG. 21 is a flowchart of an authentication management process according to the first embodiment;

FIG. 22 is a flowchart of a configuration data generation process according to the first embodiment;

FIG. 23 is a flowchart of a function correlation generation process according to the first embodiment;

FIG. 24 is a configuration diagram of a vehicle communication apparatus 100 according to a variation of the first embodiment;

FIG. 25 is a configuration diagram of an authentication management apparatus 300 according to a variation of the first embodiment;

FIG. 26 is a configuration diagram of an in-vehicle authentication system 10 according to a second embodiment;

FIG. 27 is a configuration diagram of a vehicle communication apparatus 100a according to the second embodiment;

FIG. 28 is a configuration diagram of an authentication management apparatus 300a according to the second embodiment;

FIG. 29 is a configuration diagram of an in-vehicle authentication system 10b according to a third embodiment; and

FIG. 30 is a configuration diagram of a vehicle communication apparatus 100b according to the third embodiment.

### DESCRIPTION OF EMBODIMENTS

Embodiments of the present invention will be described hereinafter with reference to the drawings. Note that in the drawings, the same or corresponding portions are denoted by the same reference sings. In the description of the embodiments, description of the same or corresponding portions will be simplified or omitted as appropriate.

### First Embodiment

### Description of Configuration

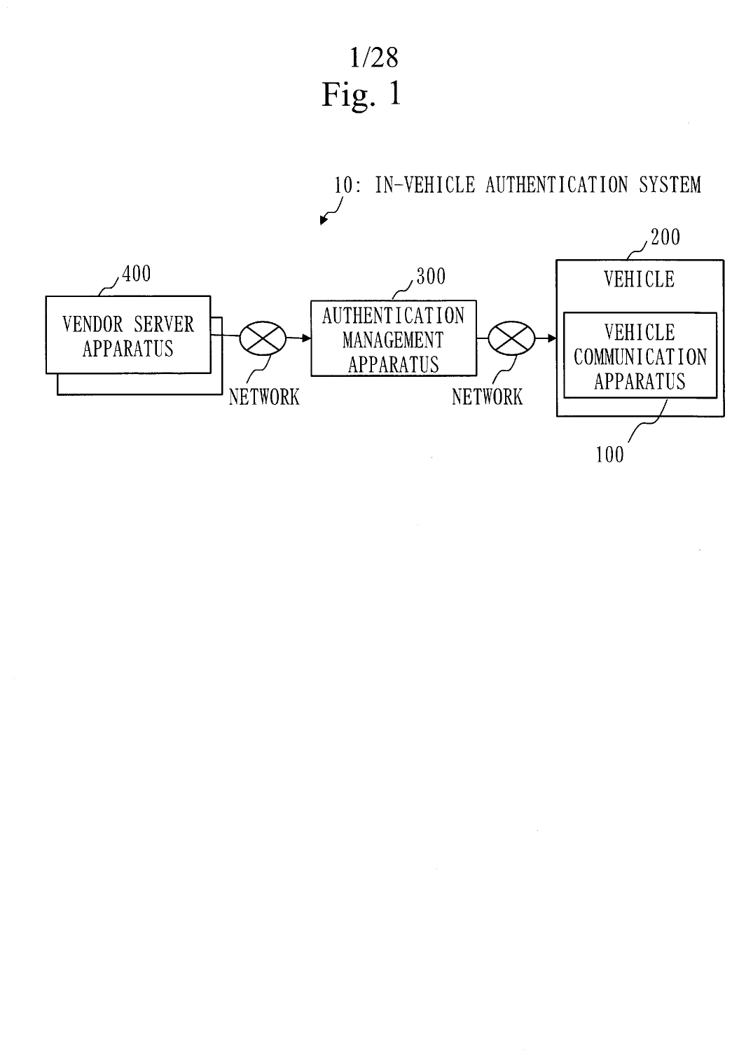

A configuration of an in-vehicle authentication system 10 according to this embodiment will be described with reference to FIG. 1.

The in-vehicle authentication system 10 includes a vehicle 200, an authentication management apparatus 300, and a vendor server apparatus 400. The vehicle 200, the authentication management apparatus 300, and the vendor server apparatus 400 communicate via a network. A specific example of the network is the Internet.

The vehicle 200 is equipped with at least two or more electronic control units that communicate with one another. An electronic control unit is called an ECU. In the following, the electronic control unit will be referred to as the ECU. The vehicle 200 has an in-vehicle network conforming to a communication protocol such as the Controller Area Network (CAN) or FlexRay. A plurality of ECUs installed in the vehicle 200 communicate with one another via the in-vehicle network. The vehicle 200 also includes a vehicle communication apparatus 100. The vehicle communication apparatus 100 communicates with each electronic control unit of the plurality of electronic control units.

The vehicle 200 is also called a vehicle system. Specifically, the vehicle communication apparatus 100 is a gateway device of the vehicle 200.

The vendor server apparatus 400 is a server apparatus managed by an ECU vendor that exists for each ECU. Therefore, there are a plurality of vendor server apparatuses 400. The vendor server apparatus 400 provides update software and update ECU information. The update software is the latest software for adding functions, changing functions, or fixing bugs. In the vehicle 200, a program of an ECU is brought to the latest state by downloading the update software and updating or changing the program in the current state. The update ECU information is information for conveying details of a change when software or hardware of the vehicle 200 has been changed due to a software update or addition of a new ECU.

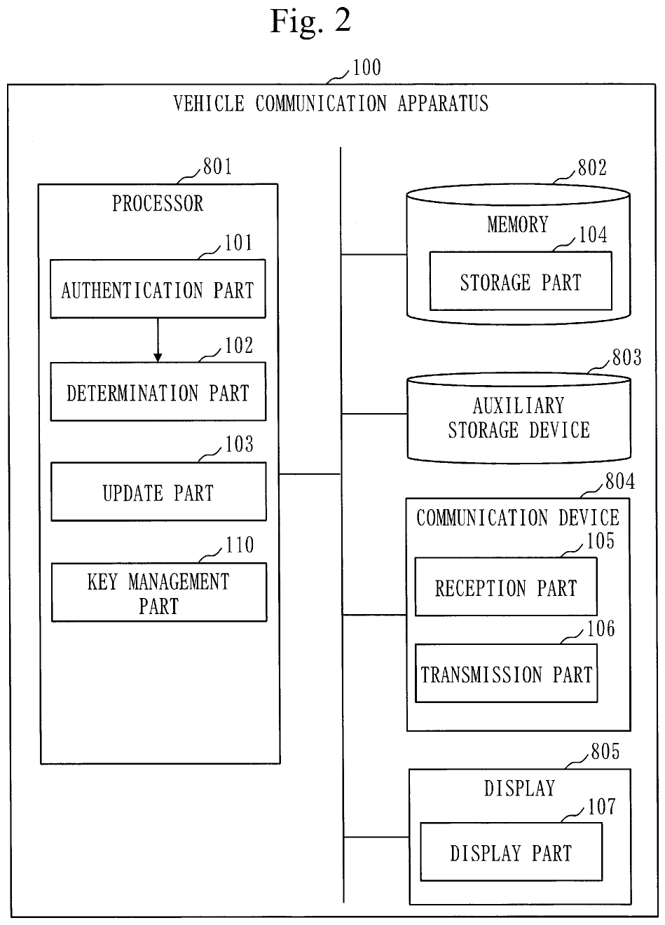

A configuration of the vehicle communication apparatus 100 according to this embodiment will be described with reference to FIG. 2.

The vehicle communication apparatus 100 authenticates the validity of an ECU of the vehicle 200. Upon detecting an unauthorized ECU, the vehicle communication apparatus 100 excludes the unauthorized ECU, determines remaining available in-vehicle functions, and displays a determination result to a user.

The vehicle communication apparatus 100 is a computer that includes hardware such as a processor 801, a memory 802, an auxiliary storage device 803, a communication device 804, and a display 805.

The processor 801 is connected with other hardware components via signal lines. The processor 801 is an integrated circuit (IC) that performs arithmetic processing and controls the other hardware components. Specifically, the processor 801 is a CPU, a DSP, or a GPU. CPU is an abbreviation for Central Processing Unit, DSP is an abbreviation for Digital Signal Processor, and GPU is an abbreviation for Graphics Processing Unit.

The memory 802 is a volatile storage device. The memory 802 is also called a main storage device or a main memory. Specifically, the memory 802 is a random access memory (RAM).

The auxiliary storage device 803 is a non-volatile storage device. Specifically, the auxiliary storage device 803 is a ROM, an HDD, or a flash memory. ROM is an abbreviation for Read Only Memory, and HDD is an abbreviation for Hard Disk Drive.

The communication device 804 is a device that performs communication and includes a receiver and a transmitter. Specifically, the communication device 804 is a communication chip or a network interface card (NIC).

The display 805 is a display device that displays an image or the like. Specifically, the display 805 is a liquid crystal display. The display 805 is also called a monitor.

The vehicle communication apparatus 100 includes, as components, an authentication part 101, a determination part 102, an update part 103, and a key management part 110. The functions of the authentication part 101, the determination part 102, the update part 103, and the key management part 110 are realized by software.

The auxiliary storage device 803 stores programs for realizing the functions of the authentication part 101, the determination part 102, the update part 103, and the key management part 110. The programs for realizing the functions of the authentication part 101, the determination part 102, the update part 103, and the key management part 110 are loaded into the memory 802 and executed by the processor 801.

In addition, the auxiliary storage device 803 stores an operating system (OS). At least part of the OS is loaded into the memory 802 and executed by the processor 801.

That is, the processor 801 executes the programs for realizing the functions of the authentication part 101, the determination part 102, the update part 103, and the key management part 110 while executing the OS.

Data obtained by executing the programs for realizing the functions of the authentication part 101, the determination part 102, the update part 103, and the key management part 110 are stored in a storage device such as the memory 802, the auxiliary storage device 803, a register in the processor 801, or a cache memory in the processor 801.

Note that the vehicle communication apparatus 100 may include a plurality of processors 801 and the plurality of processors 801 may cooperate to execute the programs for realizing the functions of the authentication part 101, the determination part 102, the update part 103, and the key management part 110.

The memory 802 functions as a storage part 104 to store data used, generated, input and output, or transmitted and received in the vehicle communication apparatus 100. However, a storage device other than the memory 802 may function as the storage part 104.

The communication device 804 functions as a communication part to communicate data. In the communication device 804, the receiver functions as a reception part 105 to receive data, and the transmitter functions as a transmission part 106 to transmit data.

The display 805 functions as a display part 107 to display an image or the like.

“Part” of the authentication part 101, the determination part 102, the update part 103, and the key management part 110 may be replaced with “process” or “step”. The functions of the authentication part 101, the determination part 102, the update part 103, and the key management part 110 may be realized by firmware.

The programs for realizing the functions of the authentication part 101, the determination part 102, the update part 103, and the key management part 110 may be stored in a non-volatile storage medium, such as a magnetic disk, an optical disc, or a flash memory.

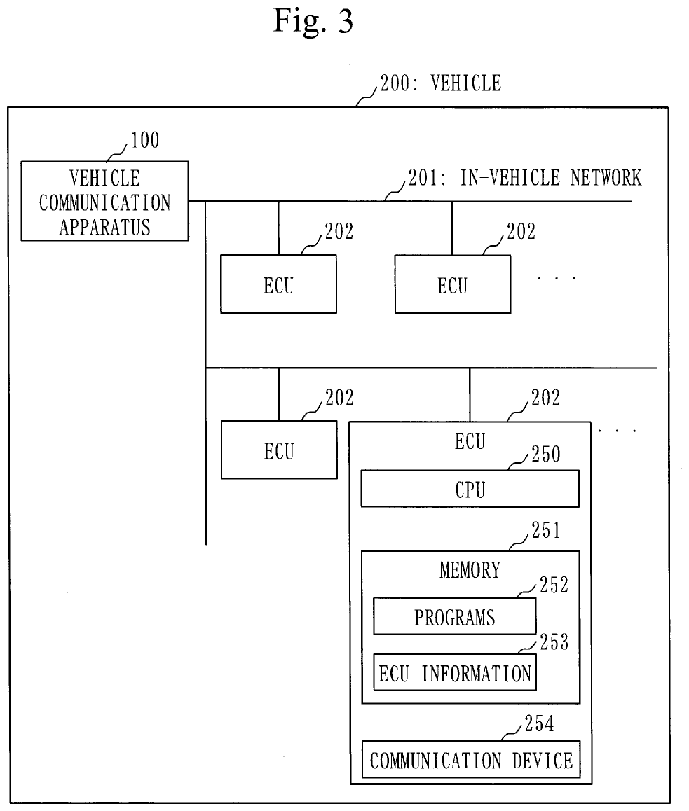

A configuration of the vehicle 200 according to this embodiment will be described with reference to FIG. 3. The vehicle 200 is a vehicle equipped with at least two or more ECUs 202 that communicate with one another. At least two or more ECUs 202 are connected with one another via an in-vehicle network 201 conforming to a communication protocol such as the CAN or FlexRay.

The ECU 202 includes hardware such as a CPU 250, a memory 251, and a communication device 254. The memory 251 stores programs 252 and ECU information 253.

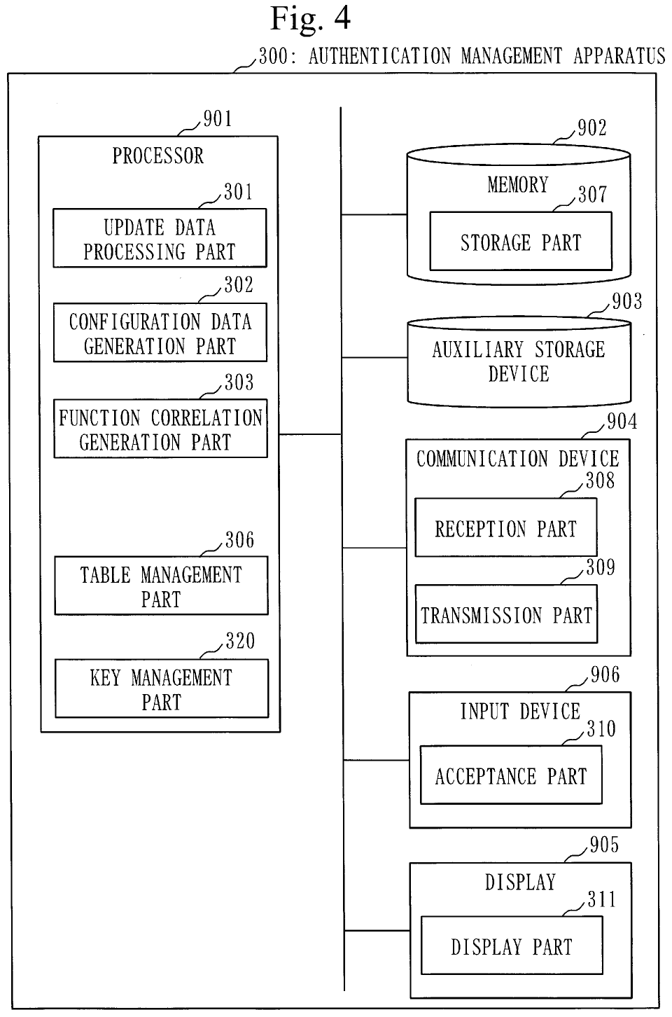

A configuration of the authentication management apparatus 300 according to this embodiment will be described with reference to FIG. 4.

The authentication management apparatus 300 is a computer that includes hardware such as a processor 901, a memory 902, an auxiliary storage device 903, a communication device 904, a display 905, and an input device 906. The processor 901, the memory 902, the auxiliary storage device 903, the communication device 904, and the display 905 are substantially the same as the hardware included in the vehicle communication apparatus 100. A storage part 307, a reception part 308, a transmission part 309, and a display part 311 are also substantially the same as the storage part 104, the reception part 105, the transmission part 106, and the display part 107 included in the vehicle communication apparatus 100. However, the authentication management apparatus 300 is a computer that functions as a server, whereas the vehicle communication apparatus 100 is a computer for embedded devices. Therefore, the authentication management apparatus 300 is a computer with significantly higher computing power compared with the vehicle communication apparatus 100.

The input device 906 functions as an acceptance part 310 to accept input.

The authentication management apparatus 300 includes, as components, an update data processing part 301, a configuration data generation part 302, a function correlation generation part 303, a table management part 306, and a key management part 320.

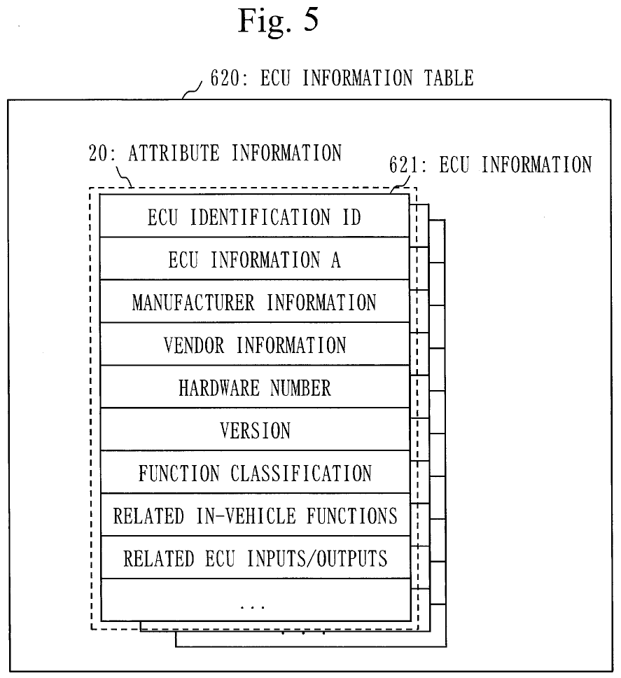

FIG. 5 is an example illustrating details of an ECU information table 620 according to this embodiment.

ECU information 621 is an example of attribute information 20 which indicates attributes of an ECU. The ECU information table 620 includes a plurality of pieces of ECU information 621. The plurality of pieces of ECU information 621 are managed with ECU identification IDs for identifying individual pieces of ECU information 621. The ECU information 621 includes, as attributes of an ECU, information such as an ECU identification ID, an ECU information name, manufacturer information, vendor information, a hardware number, a version, a function classification, related in-vehicle functions, and related ECU inputs/outputs.

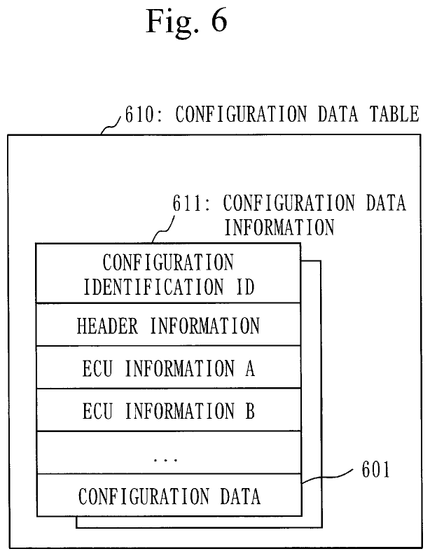

FIG. 6 is an example illustrating details of a configuration data table 610 according to this embodiment.

The configuration data table 610 is composed of a plurality of pieces of configuration data information 611. The configuration data information 611 is information in which each ECU is associated with configuration data 601 generated from ECU information indicating attributes of each ECU. Specifically, the configuration data 601 is a digital signature.

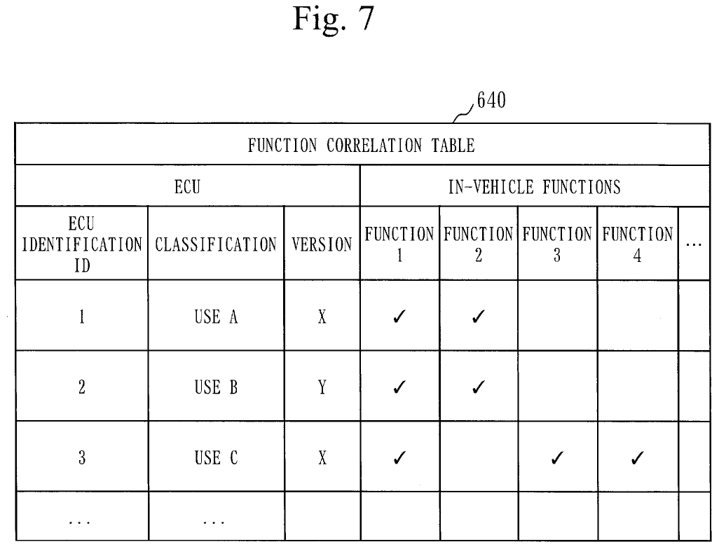

The plurality of pieces of configuration data information 611 are managed with configuration identification IDs for identifying individual pieces of configuration data information 611. The configuration data information 611 includes information such as a configuration identification ID, header information, an ECU information name, and a digital signature calculated from the ECU information. The configuration data information 611 includes one or more ECU information names. In FIG. 7, configuration data 601 calculated from ECU information 621 of each of ECU information A and ECU information B is set in the configuration data information 611.

FIG. 7 is an example illustrating details of a function correlation table 640 according to this embodiment.

The function correlation table 640 indicates the correlation between in-vehicle functions realized in the vehicle 200 and ECUs used to realize the in-vehicle functions. The in-vehicle functions are functions installed in the vehicle 200. Specific examples of the in-vehicle functions are functions such as automatic driving, ACC, LKAS, LDW, parking assist, and automatic braking. ACC stands for adaptive cruise control. LKAS stands for lane keeping assist system. LDW stands for lane departure warning.

The function correlation table 640 includes an ECU column and an in-vehicle function column. In the ECU column, an ECU identification ID for identifying each ECU, a classification indicating a use for each ECU, and a version of each ECU are set. The in-vehicle function column includes columns for individual functions, and check marks are set to indicate ECUs necessary for individual functions concerned.

### Description of Operation

An in-vehicle authentication method by the in-vehicle authentication system 10 will now be described. The operation of the in-vehicle authentication system 10 corresponds to the in-vehicle authentication method. A procedure of the in-vehicle authentication method corresponds to a procedure of an in-vehicle authentication process by an in-vehicle authentication program.

In this embodiment, the in-vehicle authentication process has a function management process by the vehicle communication apparatus 100 and an authentication management process by the authentication management apparatus 300.

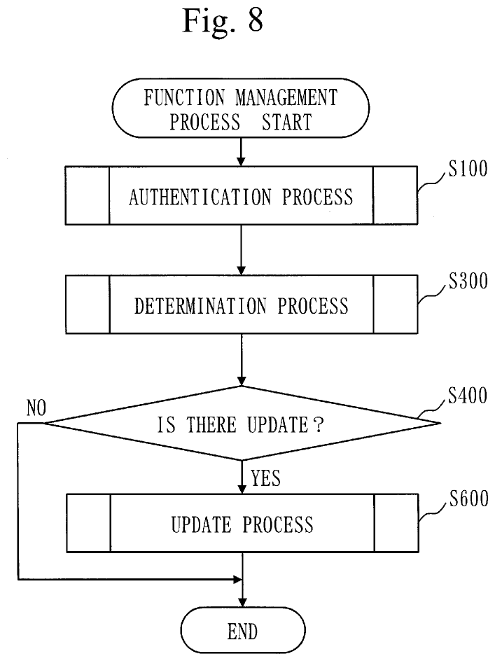

The operation of the vehicle communication apparatus 100 corresponds to a function management method. A procedure of the function management method corresponds to a procedure of a function management process by a function management program. The operation of the vehicle communication apparatus 100 will be described below with reference to FIGS. 8 to 19.

Note that the configuration data table 610, the function correlation table 640, and an authentication error table 631 to be described later are stored in the auxiliary storage device 803. When the function management process is started, the configuration data table 610, the function correlation table 640, and the authentication error table 631 are saved in the storage part 104. Keys for signature verification for individual ECU identification IDs are stored in the auxiliary storage device 803. When the function management process is started, the keys for signature verification for individual ECU identification IDs are saved in the storage part 104 by the key management part 110.

<Function Management Process>

A procedure of the function management process according to this embodiment will be described with reference to FIG. 8.

In step S100, an authentication process is performed by the authentication part 101.

In step S100, the authentication part 101 performs configuration authentication for authenticating the validity of a configuration for each ECU of the plurality of ECUs, and registers an ECU that has failed the configuration authentication in an authentication error list 630. Specifically, the authentication part 101 acquires ECU information indicating attributes of each ECU from each ECU of the plurality of ECUs, and calculates a signature of each ECU based on the ECU information. The authentication part 101 compares the signature with configuration data 601 included in the configuration data table 610. Then, when the signature matches the configuration data 601, the authentication part 101 determines that the configuration authentication of the ECU is successful.

<<Authentication Process>>

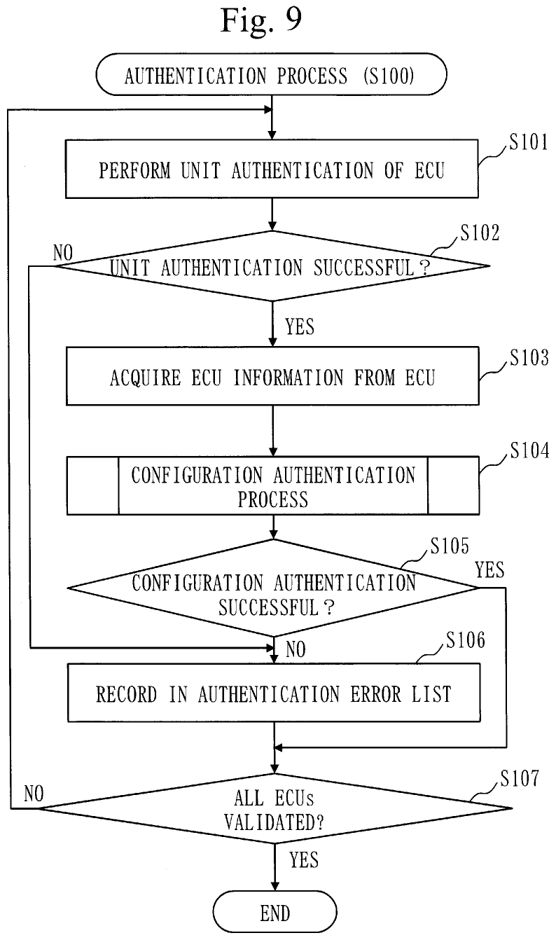

A procedure of the authentication process according to this embodiment will be described with reference to FIG. 9.

In step S101, the authentication part 101 performs unit authentication for one or more ECUs using an authentication mechanism. Specifically, the authentication part 101 performs the unit authentication using ISO/IEC 9798 which is a protocol provided as an international standard technology by the ISO/IEC. Alternatively, the authentication part 101 may perform physical unit authentication to detect an unauthorized unit in combination with the authentication mechanism.

In step S102, the authentication part 101 determines a result of the unit authentication. If the unit authentication is successful, the authentication part 101 proceeds to step S103. If the unit authentication is unsuccessful, the authentication part 101 proceeds to step S106, and records the ECU that has failed the unit authentication in the authentication error list 630. Note that the authentication error list 630 is initialized before start of the authentication process.

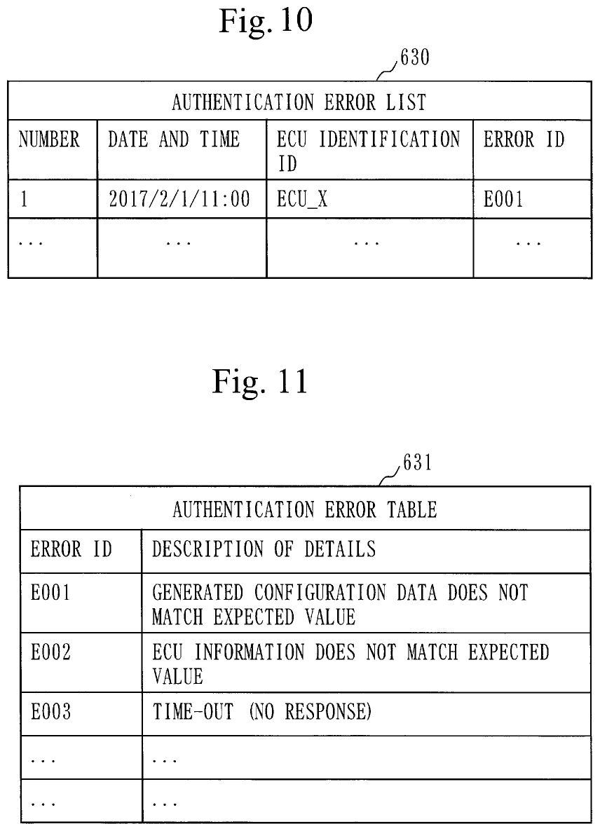

FIG. 10 is a diagram illustrating an example of the authentication error list 630 according to this embodiment.

In the authentication error list 630, information is set which includes a number indicating a row number, a date and time of occurrence of an error, an ECI identification ID of an unauthorized ECU in which the error has occurred, and an error ID indicating details of the error.

FIG. 11 is a diagram illustrating an example of the authentication error table 631 according to this embodiment.

In the authentication error table 631, an error ID and a description of details of the error indicated by the error ID are set.

In step S103, the authentication part 101 acquires ECU information 253 from the ECU for which the unit authentication has been successful, and proceeds to step S104. Note that the configuration of the ECU information 253 acquired from the ECU is substantially the same as the configuration of the ECU information 621 described with reference to FIG. 5.

<<<Configuration Authentication Process>>>

In step S104, a configuration authentication process is performed.

In step S104, the authentication part 101 generates configuration data from the ECU information 253 acquired from the ECU for which the unit authentication has been successful. Then, the authentication part 101 performs matching of the generated configuration data with the configuration data table 610.

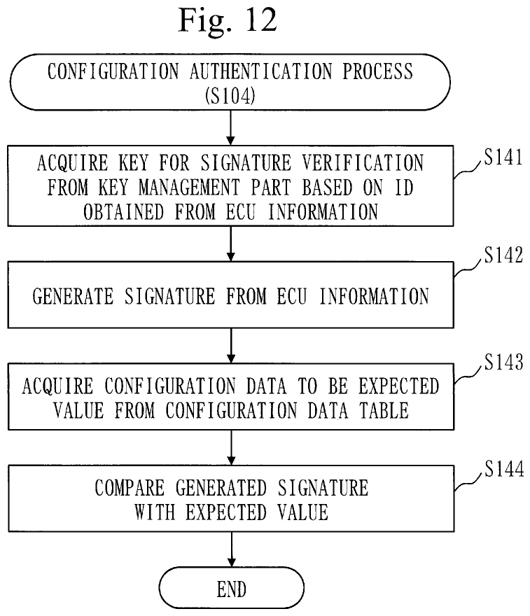

A procedure of the configuration authentication process according to this embodiment will be described in detail with reference to FIG. 12.

In step S141, the authentication part 101 acquires a key for signature verification from the storage part 104 via the key management part 110, based on the ECU identification ID acquired from the ECU information 253.

In step S142, the authentication part 101 generates configuration data using the ECU information 253 and the key for signature verification. Specifically, the authentication part 101 calculates a signature from the ECU information 253 and the key for signature verification. The signature calculated here is the configuration data.

In step S143, the authentication part 101 extracts configuration data information 611 from the configuration data table 610 saved in the storage part 104, based on the ECU information 253. The authentication part 101 acquires configuration data 601 included in the extracted configuration data information 611 as an expected value.

In step S144, the authentication part 101 compares the signature calculated in step S142 with the configuration data 601 which is the expected value acquired in step S143. The authentication part 101 compares the signature calculated in step S142 with the configuration data 601 acquired in step S143, and obtains a comparison result as to whether there is a match between them.

Referring back to FIG. 9, the description is continued.

In step 105, the authentication part 101 determines whether or not the configuration authentication is successful based on the comparison result output by the configuration authentication process. If the comparison result is a match, the authentication part 101 determines that the configuration authentication is successful. If the comparison result is a non-match, the authentication part 101 determines that the configuration authentication is unsuccessful. If the configuration authentication is successful, the authentication part 101 proceeds to step S107. If the configuration authentication is unsuccessful, the authentication part 101 records the ECU that has failed the configuration authentication in the authentication error list 630 in step S106.

In step S107, the authentication part 101 determines whether the process from step S101 to step S106 has been completed for all ECUs. If there is an ECU for which the process has not been completed, the authentication part 101 returns to step S101. If there is no ECU for which the process has not been completed, the authentication part 101 ends the authentication process.

<<Determination Process>>

Referring back to FIG. 8, the description is continued from step S300.

In step S300, a determination process is performed by the determination part 102.

In step S300, the determination part 102 determines in-vehicle functions that can be realized in the vehicle based on the function correlation table 640 and the authentication error list 630. The determination part 102 disconnects each ECU registered in the authentication error list 630 from the in-vehicle network 201.

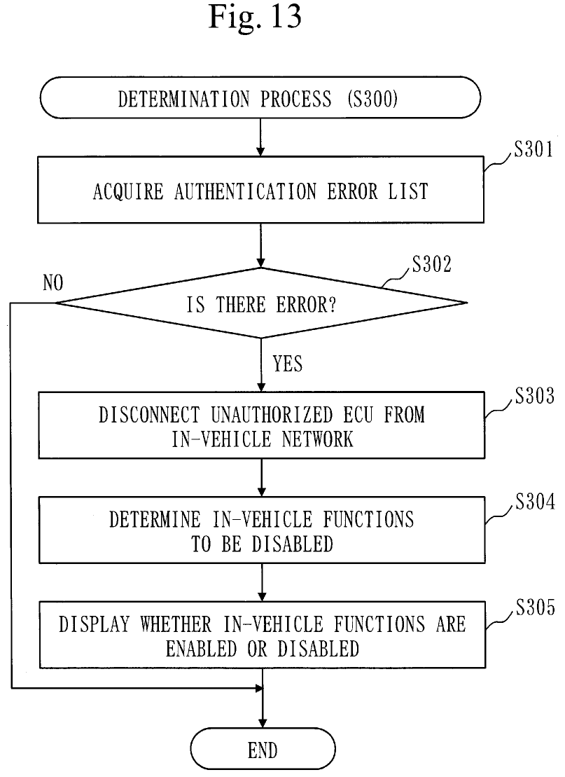

The determination process according to this embodiment will be described with reference to FIG. 13.

In step S301, the determination part 102 acquires the authentication error list 630 from the storage part 104.

In step S302, the determination part 102 determines whether an ECU is registered in the authentication error list 630. If no ECU is registered in the authentication error list 630, this means that there is no authentication-error ECU. Thus, the determination part 102 determines that the authentication is successful and ends the process. If an ECU is registered in the authentication error list 630, this means that there is an authentication-error ECU. Thus, the determination part 102 determines that the authentication is unsuccessful and proceeds to step S303.

In step S303, the determination part 102 excludes the unauthorized ECU in which the authentication error has occurred by logically disconnecting it from the in-vehicle network 201. A specific method for exclusion may be a method of logical disconnection by making other ECUs ignore a communication frame transmitted by the unauthorized ECU.

In step S304, the determination part 102 determines in-vehicle functions related to the ECU excluded in step S303, using the function correlation table 640. That is, the determination part 102 determines in-vehicle functions that can be realized in the vehicle 200 and determines in-vehicle functions to be disabled.

In step S305, a display process by the display part 311 is performed. In step S305, the display part 311 displays the in-vehicle functions determined to be realizable in the vehicle 200 on the display 805 of the vehicle communication device. Specifically, the display part 311 displays on the display 805 a function display screen 500 which displays whether each in-vehicle function is enabled or disabled. By displaying the function display screen 500, the display part 311 distinguishably presents to a driver of the vehicle 200 the functions that have been disabled and the functions that are still enabled among the in-vehicle functions. The display part 311 may display an explanation as to an occurrence of an increase or decrease in the in-vehicle functions that can be provided to the driver.

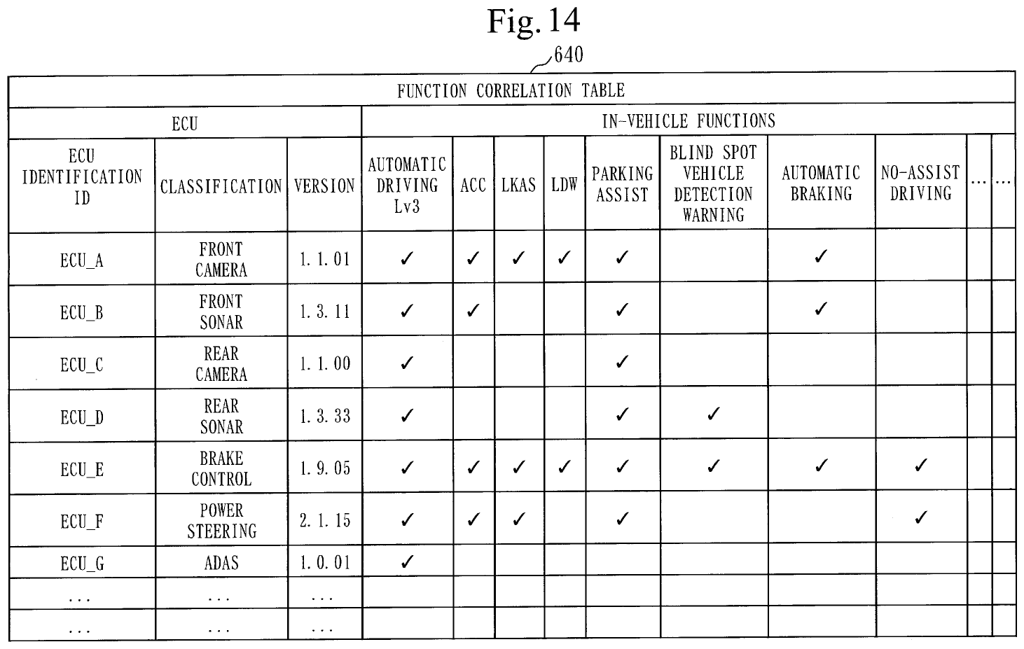

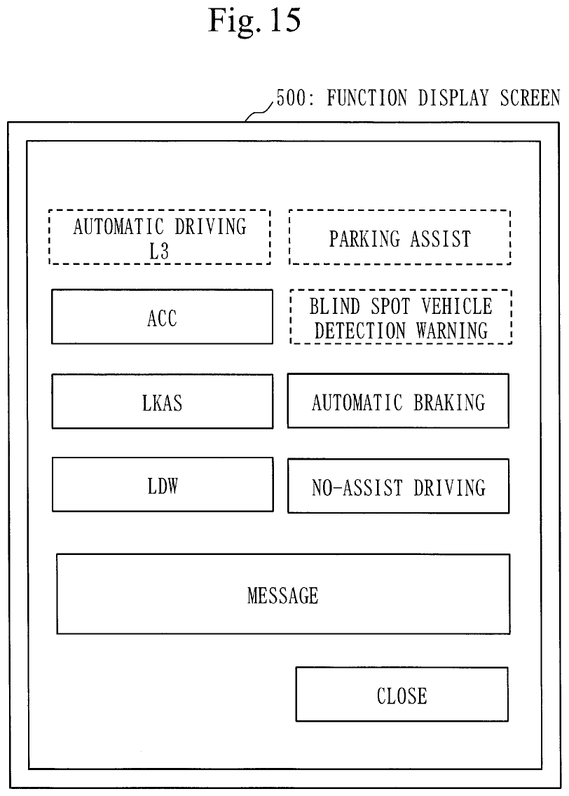

FIG. 14 is a diagram illustrating a specific example of the function correlation table 640 according to this embodiment. FIG. 15 is a diagram illustrating the function display screen 500 according to this embodiment.

A specific example of the determination process will be described with reference to FIGS. 14 and 15.

It is assumed that an unauthorized ECU in which an authentication error has occurred is a rear sonar of ECU_D as illustrated in FIG. 14. In this case, the determination part 102 determines that in-vehicle functions related to ECU_D are automatic driving, parking assist, and blind spot vehicle detection warning. Therefore, as illustrated in FIG. 15, the display part 311 indicates on the function display screen 500 that automatic driving, parking assist, and blind spot vehicle detection warning are disabled. The display part 311 also displays an explanation that an authentication error has occurred in the rear sonar of ECU_D in the message field of the function display screen 500.

Referring back to FIG. 8, the description is continued from step S400.

In step S400, the update part 103 determines whether the reception part 105 of the communication device 804 has received an update notification from the authentication management apparatus 300. If there is an update notification, the update part 103 proceeds to step S600. If there is no update notification, the update part 103 ends the process.

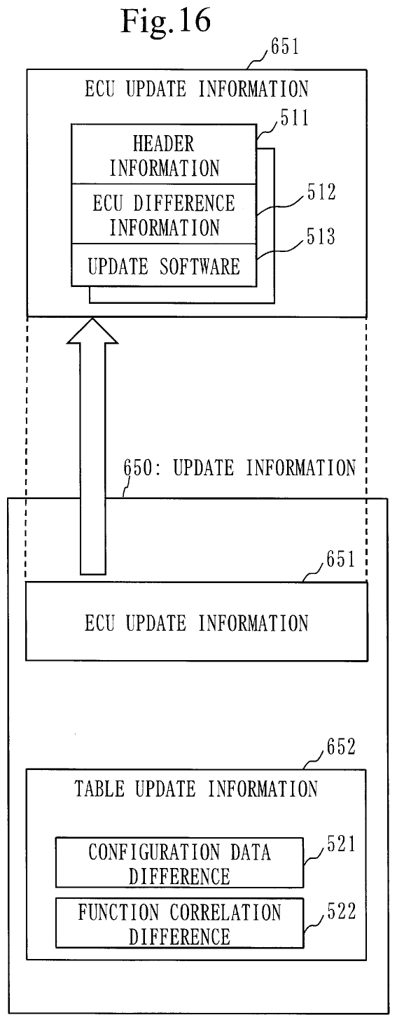

FIG. 16 is a diagram illustrating a configuration of update information 650 according to this embodiment.

The update information 650 includes ECU update information 651 and table update information 652.

In the ECU update information 651, header information 511, ECU difference information 512, and update software 513 are set in a table for each ECU. The header information 511 indicates the ECU concerned, and the ECU difference information 512 is a changed portion of the ECU information, that is, a difference from the ECU information before the change.

In the table update information 652, a configuration data difference 521 is set. The configuration data difference 521 is details of an update of the configuration data table, that is, a difference from the configuration data table before the change. In the table update information 652, a function correlation difference 522 is set. The function correlation difference 522 is details of an update of the function correlation table, that is, a difference from the function correlation table before the change.

Upon receiving the update information 650, the update part 103 determines that an update notification has been received.

<<Update Process>>

In step S600, an update process is performed by the update part 103.

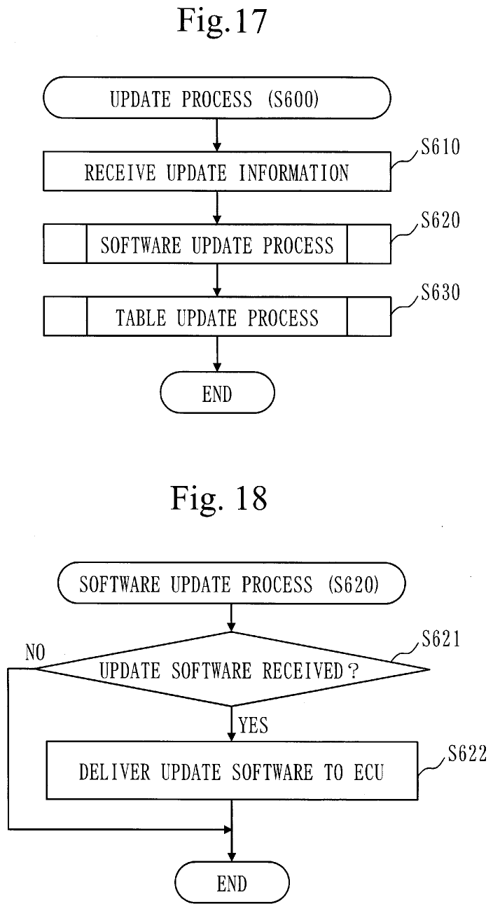

A procedure of the update process according to this embodiment will be described with reference to FIG. 17.

In step S610, the update part 103 receives update information 650 via the reception part 105.

In step S620, a software update process is performed by the update part 103.

Then, in step S630, a table update process is performed by the update part 103.

A procedure of the software update process according to this embodiment will be described with reference to FIG. 18.

In step S621, the update part 103 determines whether update software 513 is included in the update information 650. If update software 513 is included in the update information 650, the update part 103 proceeds to step S622. If update software 513 is not included in the update information 650, the update part 103 ends the process.

In step S622, the update part 103 determines an ECU to be updated based on header information 511 in the update information 650. The update part 103 delivers the ECU difference information 512 and the update software 513 to the ECU to be updated, using the transmission part 106 and via the in-vehicle network 201. After delivering the ECU difference information 512 and the update software 513 to all ECUs to be updated, the update part 103 ends the process. As the update information delivered to each ECU, only difference information is transmitted.

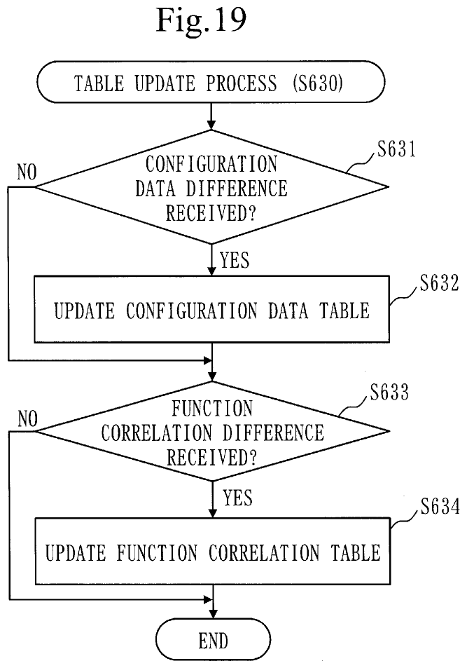

A procedure of the table update process according to this embodiment will be described with reference to FIG. 19.

In step S631, the update part 103 determines whether a configuration data difference 521 is included in the update information 650. If a configuration data difference 521 is included in the update information 650, the update part 103 proceeds to step S632. If a configuration data difference 521 is not included in the update information 650, the update part 103 proceeds to step S633.

In step S632, the update part 103 updates the configuration data table 610 in the auxiliary storage device 803, using the configuration data difference 521.

In step S633, the update part 103 determines whether a function correlation difference 522 is included in the update information 650. If a function correlation difference 522 is included in the update information 650, the update part 103 proceeds to step S634. If a function correlation difference 522 is not included in the update information 650, the update part 103 ends the process.

In step S634, the update part 103 updates the function correlation table 640 in the auxiliary storage device 803, using the function correlation difference 522. Note that the update part 103 may refer to the update information 650, and if it is found that the update has caused a change in the ECU functions, may update the function correlation table 640 in step S634.

The above completes the description of the function management process by the vehicle communication apparatus 100.

The operation of the authentication management apparatus 300 according to this embodiment will now be described. Specifically, the authentication management apparatus 300 is a server that exists outside the vehicle 200. Alternatively, the authentication management apparatus 300 is part of a server that exists outside the vehicle 200.

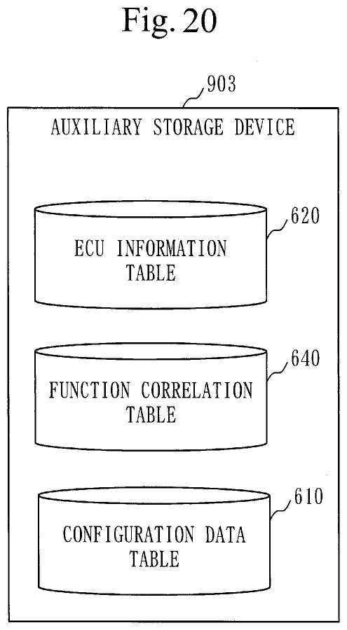

FIG. 20 is a diagram illustrating a configuration of the auxiliary storage device 903 of the authentication management apparatus 300 according to this embodiment. As illustrated in FIG. 20, the auxiliary storage device 903 stores the ECU information table 620, the configuration data table 610, and the function correlation table 640.

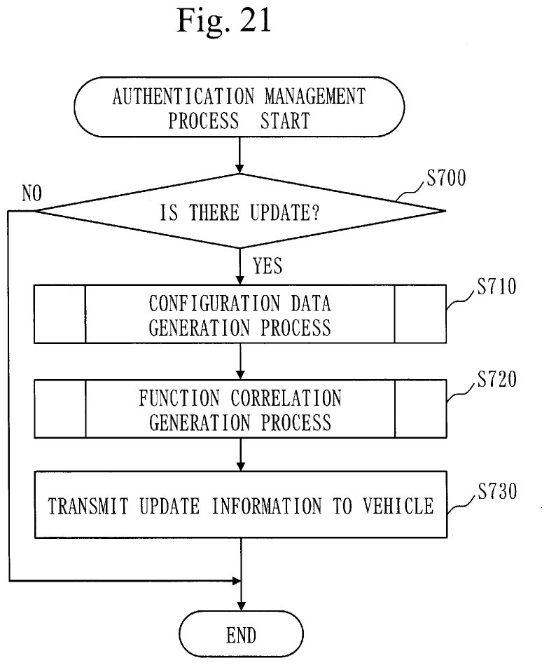

The operation of the authentication management apparatus 300 will be described below with reference to FIGS. 21 to 23. The operation of the authentication management apparatus 300 corresponds to an authentication management method. A procedure of the authentication management method corresponds to a procedure of an authentication management process by an authentication management program.

Note that the configuration data table 610, the function correlation table 640, and the authentication error table 631 to be described later are stored in the auxiliary storage device 903. When the authentication management process is started, the configuration data table 610, the function correlation table 640, and the authentication error table 631 are saved in the storage part 307. Keys for signature verification for individual ECU identification IDs are stored in the auxiliary storage device 903. When the authentication management process is started, the keys for signature verification for individual ECU identification IDs are saved in the storage part 307 by the key management part 320.

<Authentication Management Process>

A procedure of the authentication management process according to this embodiment will be described with reference to FIG. 21.

In step S700, the update data processing part 301 determines whether there is an update from the vendor server apparatus 400. If the update data processing part 301 has received ECU update information 651 via the reception unit 308, this means that there is an update from the vendor server apparatus 400. If there is an update from the vendor server apparatus 400, the update data processing part 301 proceeds to step S710. If the update data processing part 301 has not received ECU update information 651, this means that there is no update from the vendor server apparatus. Thus, the update data processing part 301 ends the process.

Note that the ECU update information 651 is an example of unit change information which indicates a change related to an ECU of the plurality of ECUs.

<<Configuration Data Generation Process>>

In step S710, a configuration data generation process is performed.

In step S710, upon receiving the ECU update information 651 which indicates a change related to an ECU of the plurality of ECUs, the configuration data generation part 302 updates the configuration data table 610 based on the ECU update information 651.

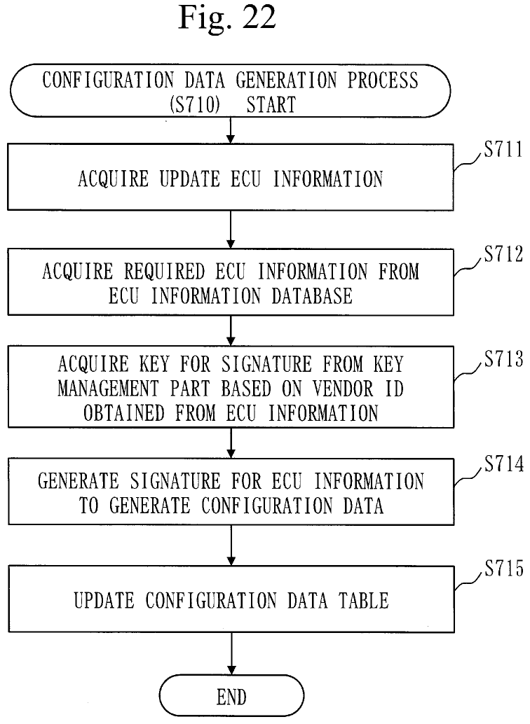

A procedure of the configuration data generation process according to this embodiment will be described with reference to FIG. 22.

In step S711, the configuration data generation part 302 acquires header information 511 and ECU difference information 512 from the ECU update information 651. The header information 511 includes an ECU identification ID of an ECU to be updated.

In step S712, the configuration data generation part 302 extracts, from the ECU information table 620, ECU information of the ECU corresponding to the ECU identification ID included in the header information 511.

In step S713, the configuration data generation part 302 acquires vendor information included in the extracted ECU information. The configuration data generation part 302 acquires, from the key management part 320, a key for signature associated with a vendor ID which is set in the vendor information.

In step S714, the configuration data generation part 302 calculates a new digital signature based on the key acquired from the key management part 320, the ECU information extracted from the ECU information table 620, and the ECU difference information 512. Specifically, the configuration data generation part 302 calculates a digital signature for the ECU information of one or more ECUs, using the acquired key. The configuration data generation part 302 generates configuration data information 611 based on the ECU information of one or more ECUs, and adds the calculated digital signature as configuration data 601 to the configuration data information 611 so as to generate new configuration data information 611.

In step S715, the table management part 306 registers the new configuration data information 611 generated by the configuration data generation part 302 in the configuration data table 610. This causes the configuration data table 610 to be updated.

<<Function Correlation Generation Process>>

In step S720, a function correlation generation process is performed.

In step S720, the function correlation generation part 303 updates the function correlation table 640 based on the ECU update information 651 which indicates a change related to an ECU of the plurality of ECUs.

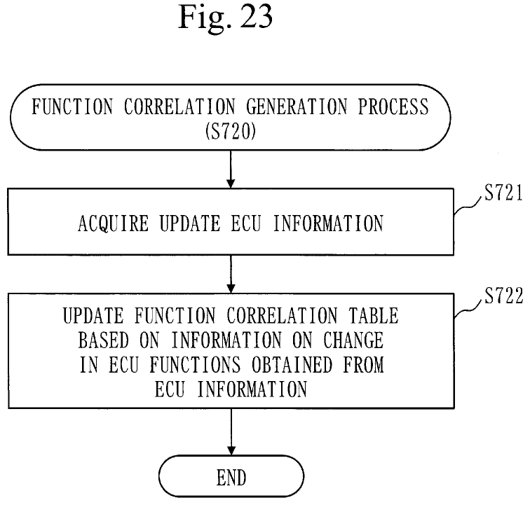

A procedure of the function correlation generation process according to this embodiment will be described with reference to FIG. 23.

In step S721, the function correlation generation part 303 acquires the header information 511 and the ECU difference information 512 from the ECU update information 651. The header information 511 includes the ECU identification ID of the ECU to be updated.

In step S722, the function correlation generation part 303 extracts, from the ECU information table 620, the ECU information of the ECU corresponding to the ECU identification ID included in the header information 511. The function correlation generation part 303 updates the function correlation table 640 based on information on the change in the ECU functions obtained from the extracted ECU information 621 of the update target. An example of a specific process for updating the function correlation table 640 will be described below. The ECU change information 651 includes information on one row, that is, a horizontal line, of the function correlation table 640. As a specific example, it is notified by the ECU change information 651 that the ECU identification ID “3” is newly related to Function 5 from a state of being related to Function 1, Function 3, and Function 4 in the function correlation table 640 of FIG. 7. By this ECU change information 651, Function 5 is added to the function correlation table 640, and a check mark is placed in Function 5 for the ECU identification ID “3”.

Referring back to FIG. 21, the description is continued from step S730.

In step S730, the update data processing part 301 generates a configuration data difference 521 which is a difference between the configuration data table 610 before the update and after the update. The update data processing part 301 also generates a function correlation difference 522 which is a difference between the function correlation table 640 before the update and after the update. The update data processing part 301 generates update information 650 including the configuration data difference 521 and the function correlation difference 522. Then, the update data processing part 301 transmits the update information 650 to the vehicle communication apparatus 100 of the vehicle 200.

### Other Configurations

<Variation 1>

The authentication part of the vehicle communication apparatus 100 may be provided in the authentication management apparatus 300. Then, the authentication management apparatus 300 may be configured to implement a portion of the authentication process. In this case, the authentication part of the vehicle communication apparatus 100 acquires ECU information from ECUs and transmits the ECU information to the authentication management apparatus 300. The authentication management apparatus 300 performs the configuration authentication based on the received ECU information, and transmits an authentication error list to the vehicle.

<Variation 2>

The determination part of the vehicle communication apparatus 100 may be provided in the authentication management apparatus 300. Then, the authentication management apparatus 300 may be configured to implement a portion of the authentication process. In this case, the determination part of the vehicle communication apparatus 100 transmits an authentication error list to the authentication management apparatus 300. Then, the authentication management apparatus 300 determines in-vehicle functions that can be implemented in the vehicle, and transmits the determination result to the vehicle.

<Variation 3>

The configuration data generation part of the authentication management apparatus 300 may be provided in the vehicle communication apparatus 100. Then, the vehicle communication apparatus 100 may be configured to implement a portion of the configuration data generation process. In this case, the vehicle communication apparatus 100 generates configuration data which is an expected value from update ECU information, and updates the configuration data table.

<Variation 4>

The function correlation generation part 303 of the authentication management apparatus 300 may be provided in the vehicle communication apparatus 100. Then, the vehicle communication apparatus 100 may be configured to implement a portion of the function correlation generation process. In this case, the vehicle communication apparatus 100 updates the function correlation table based on update ECU information.

<Variation 5>

In the in-vehicle authentication system, data transmitted and received between the authentication management apparatus 300 and the vehicle communication apparatus 100 may be encrypted in order to increase confidentiality. Alternatively, the in-vehicle authentication system may include a cryptographic processing part to add an authenticator to data transmitted and received between the authentication management apparatus 300 and the vehicle communication apparatus 100.

As a cryptographic algorithm used to generate configuration data from ECU information, a method based on public key cryptography may be used, or a method based on secret key cryptography may be used.

<Variation 6>

In this embodiment, the components of each apparatus of the vehicle communication apparatus 100 and the authentication management apparatus 300 are realized by software. As a variation, however, the components of each apparatus may be realized by hardware.

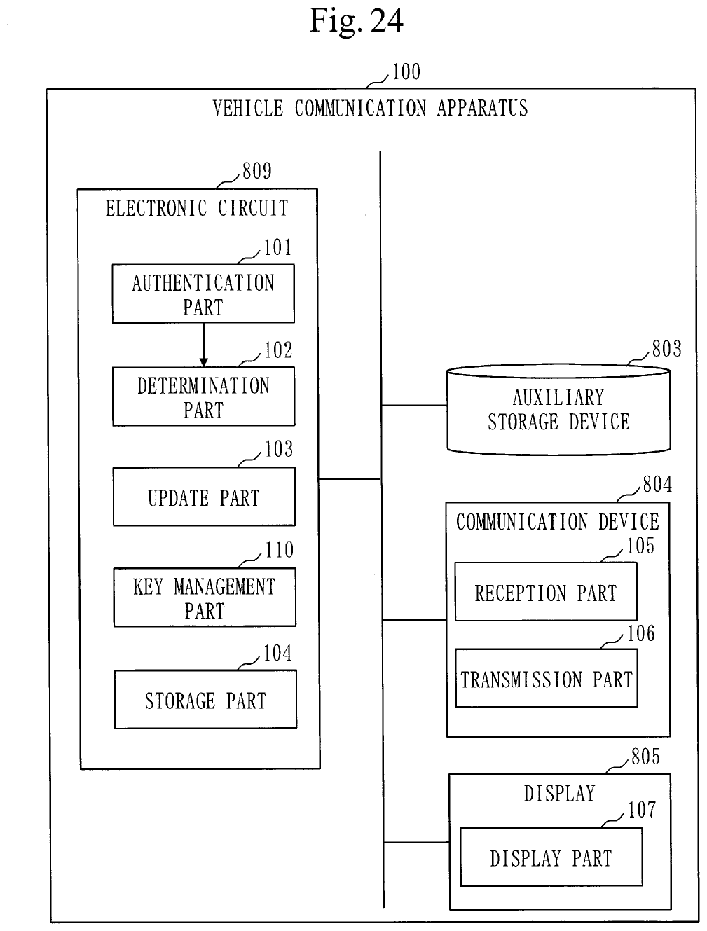

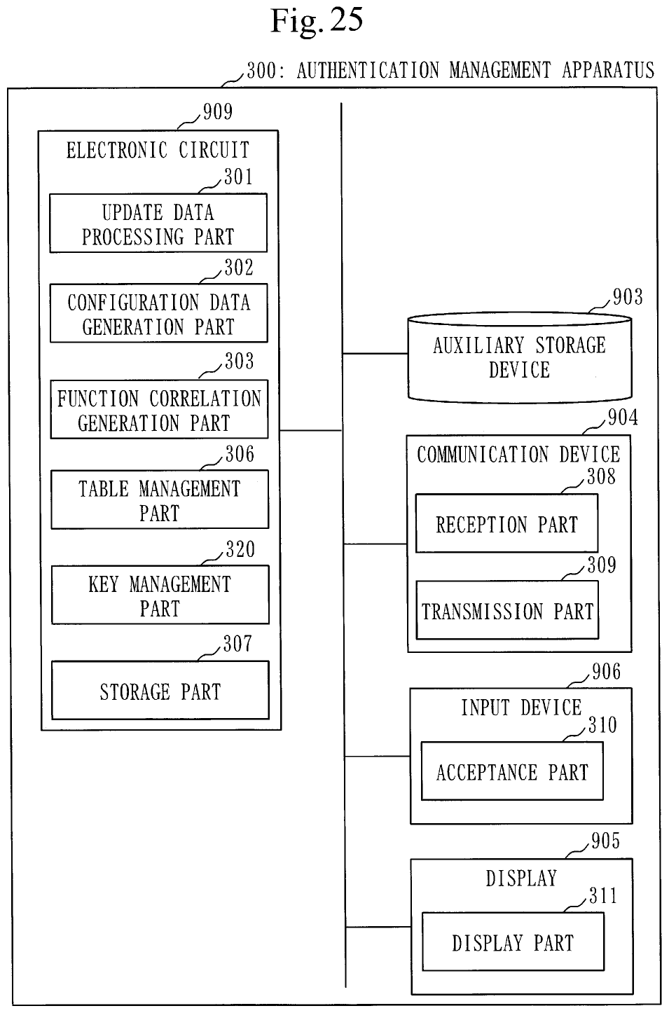

FIG. 24 is a diagram illustrating a configuration of a vehicle communication apparatus 100 according to a variation of this embodiment. FIG. 25 is a diagram illustrating a configuration of an authentication management apparatus 300 according to a variation of this embodiment.

The vehicle communication apparatus 100 includes hardware such as an electronic circuit 809, an auxiliary storage device 803, a communication device 804, and a display 805. The authentication management apparatus 300 includes hardware such as an electronic circuit 909, an auxiliary storage device 903, a communication device 904, a display 905, and an input device 906.

The electronic circuit 809 is a dedicated electronic circuit that realizes the functions of the authentication part 101, the determination part 102, the update part 103, and the key management part 110. The electronic circuit 909 is a dedicated electronic circuit that realizes the functions of the update data processing part 301, the configuration data generation part 302, the function correlation generation part 303, the table management part 306, and the key management part 320.

Specifically, each of the electronic circuits 809 and 909 is a single circuit, a composite circuit, a programmed processor, a parallel-programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of the components of each apparatus may be realized by one electronic circuit, or may be realized by being distributed among a plurality of electronic circuits.

As another variation, the functions of some of the components of each apparatus may be realized by an electronic circuit, and the rest of the functions may be realized by software.

Each processor and each electronic circuit are also called processing circuitry. That is, in the vehicle communication apparatus 100, the functions of the authentication part 101, the determination part 102, the update part 103, and the key management part 110 are realized by the processing circuitry. In the authentication management apparatus 300, the functions of the update data processing part 301, the configuration data generation part 302, the function correlation generation part 303, the table management part 306, and the key management part 320 are realized by the processing circuitry.

In the vehicle communication apparatus 100, “part” of the authentication part 101, the determination part 102, the update part 103, and the key management part 110 may be replaced with “step”. In the authentication management apparatus 300, “part” of the update data processing part 301, the configuration data generation part 302, the function correlation generation part 303, the table management part 306, and the key management part 320 may be replaced with “step”.

“Process” of the in-vehicle authentication process, the function management process, and the authentication management process may be replaced with “program”, “program product”, or “computer readable medium recording a program”.

### Description of Effects of this Embodiment

In the in-vehicle authentication system 10 according to this embodiment, an unauthorized ECU can be excluded by performing the configuration authentication for each ECU in a vehicle system. In the in-vehicle authentication system 10 according to this embodiment, the configuration authentication supporting changes in functions can be performed. In-vehicle functions can be provided by taking into consideration the cooperative operation among ECUs.

In the in-vehicle authentication system 10 according to this embodiment, the configuration authentication is performed in the in-vehicle system, so that the normal state can be checked, and assistance functions for which safety is secured can be provided. That is, by performing the configuration authentication in the in-vehicle system, an unauthorized ECU is detected and the unauthorized ECU is excluded. Then, remaining available in-vehicle functions are determined, and appropriate countermeasures are provided.

Therefore, in the in-vehicle authentication system 10 according to this embodiment, while a security problem is being resolved, that is, while the vehicle is brought to a dealer and the vehicle is being repaired, functions are not excessively disrupted although driving functions are temporarily limited. A user is made aware of in-vehicle functions that can be used, and can then drive safely using assistance functions. That is, in the in-vehicle authentication system 10 according to this embodiment, the vehicle can be used with the state of the vehicle being checked and safety being secured.

### Second Embodiment

In this embodiment, differences from the first embodiment will be described. Note that components that are substantially the same as those of the first embodiment are denoted by the same reference signs, and description thereof may be omitted.

In the first embodiment, the configuration data generation process and the function correlation process are performed in the authentication management apparatus 300, and update information is transmitted from the authentication management apparatus to the vehicle communication apparatus 100 of the vehicle 200. Then, in the vehicle communication apparatus 100, the authentication process and the determination process can be readily performed. In the first embodiment, the authentication process and the determination process are thus performed in the vehicle communication apparatus 100. In this embodiment, a configuration in which the authentication process and the determination process are performed in the authentication management apparatus 300 will be described.

### Description of Configuration

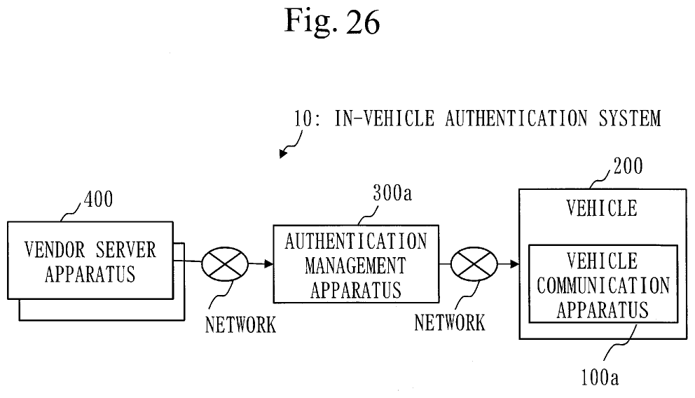

FIG. 26 is a diagram illustrating a configuration of an in-vehicle authentication system 10 according to this embodiment. As illustrated in FIG. 26, the configuration of the in-vehicle authentication system 10 is the same as that of the first embodiment. However, the functions of a vehicle communication apparatus 100a and an authentication management apparatus 300a differ from those of the first embodiment.

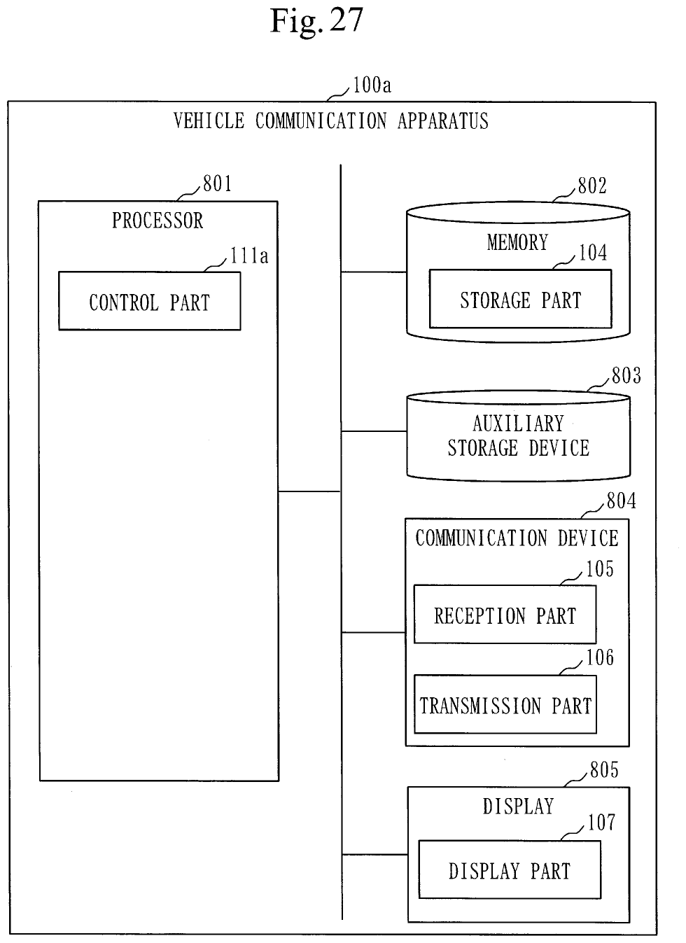

FIG. 27 is a diagram illustrating a configuration of the vehicle communication apparatus 100a according to this embodiment. The vehicle communication apparatus 100a does not include an authentication part 101, a determination part 102, and a key management part 110. The vehicle communication apparatus 100a has a control part 111a as a component. The control part 111a collects ECU information from each of a plurality of ECUs, and transmits the ECU information to the authentication management apparatus 300a. Then, the control part 111a receives an authentication error list 630 and a determination result by a determination process from the authentication management apparatus 300a. A display part 311 displays a function display screen 500 on a display 805 based on the authentication error list 630 and the determination result.

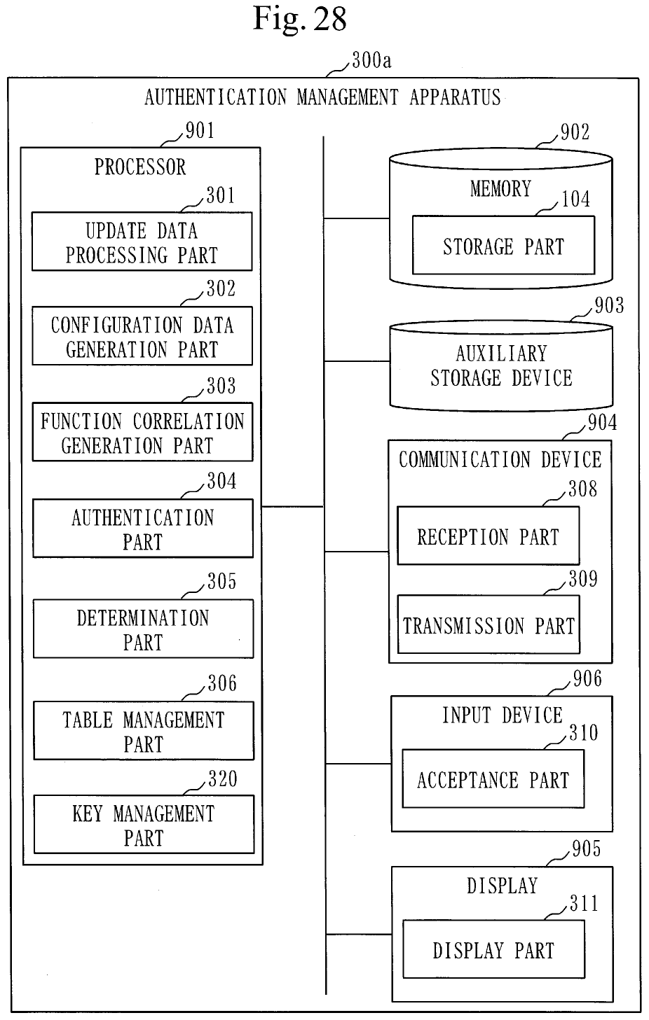

FIG. 28 is a diagram illustrating a configuration of the authentication management apparatus 300a according to this embodiment. The authentication management apparatus 300a includes an authentication part 304 and a determination part 305 in addition to the components described in the first embodiment. The authentication part 304 has substantially the same function as the authentication part 101 described in the first embodiment. The determination part 305 has substantially the same function as the determination part 102 described in the first embodiment.

### Description of Operation

In this embodiment, the authentication process and the determination process are performed in the authentication management apparatus 300a. Accordingly, ECU information, an authentication error list, and a determination result are transmitted and received between the vehicle communication apparatus 100a and the authentication management apparatus 300a. The rest of the procedures are the same as those of the first embodiment.

### Description of Effects of this Embodiment

In the in-vehicle authentication system 10 according to this embodiment, the ECU information table, the configuration data table, and the function correlation table can be managed in the authentication management apparatus 300a. Therefore, in the in-vehicle authentication system 10 according to this embodiment, the storage capacity of the vehicle communication apparatus 100a can be reduced. Note that this embodiment is premised on a state in which a vehicle is always stably and securely connected to an external network. In the in-vehicle authentication system 10 according to this embodiment, it is not necessary to perform the update process for the various tables, the authentication process, and the determination process in the vehicle communication apparatus 100a, so that the load on the vehicle communication apparatus 100a can be reduced and costs can be reduced.

### Third Embodiment

In this embodiment, differences from the first embodiment will be described. Note that components that are substantially the same as those of the first embodiment are denoted by the same reference signs, and description thereof may be omitted.

In the first embodiment, the configuration data generation process and the function correlation process are performed in the authentication management apparatus 300, and update information is transmitted from the authentication management apparatus to the vehicle communication apparatus 100 of the vehicle 200. Then, in the vehicle communication apparatus 100, the authentication process and the determination process can be readily performed. In the first embodiment, the configuration data generation process to generate a configuration data table and the function correlation generation process to generate a function correlation table are performed in the authentication management apparatus 300. In the first embodiment, the configuration data generation process and the function correlation generation process are thus performed in the authentication management apparatus 300. In this embodiment, a configuration in which the configuration data generation process and the function correlation generation process are performed in the vehicle communication apparatus 100 will be described.

### Description of Configuration

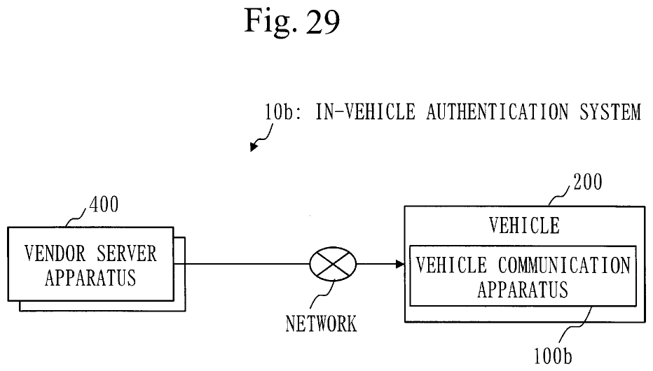

FIG. 29 is a diagram illustrating a configuration of an in-vehicle authentication system 10b according to this embodiment.

In this embodiment, the in-vehicle authentication system 10b does not have an authentication management apparatus 300. A vehicle communication apparatus 100b of a vehicle 200 receives ECU update information from a vendor server apparatus 400 without involving an authentication management apparatus 300.

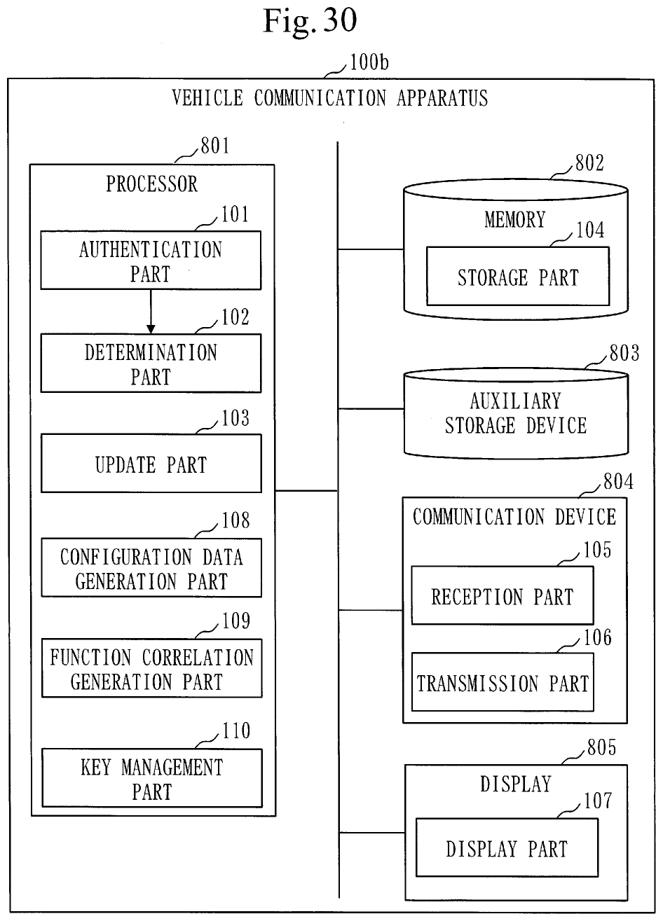

FIG. 30 is a diagram illustrating a configuration of the vehicle communication apparatus 100b according to this embodiment. The vehicle communication apparatus 100b includes a configuration data generation part 108 and a function correlation generation part 109 in addition to the components described in the first embodiment. The configuration data generation part 108 has substantially the same function as the configuration data generation part 302 described in the first embodiment. The function correlation generation part 109 has substantially the same function as the function correlation generation part 303 described in the first embodiment.

### Description of Operation

In this embodiment, the configuration data generation process and the function correlation generation process are performed in the vehicle communication apparatus 100b. The rest of the procedures are the same as those of the first embodiment.

### Description of Effects of this Embodiment

In the in-vehicle authentication system 10b according to this embodiment, there is no relay server between the vendor server apparatus 400 and the vehicle communication apparatus 100b of the vehicle 200. Therefore, in the in-vehicle authentication system 10b according to this embodiment, the same information is not held at a plurality of places but is managed in an integrated manner, so that objects for which security is to be enhanced and maintenance is to be performed are reduced. In the in-vehicle authentication system 10b according to this embodiment, costs of the overall system including management and maintenance can be reduced.

In the first to third embodiments, the parts of the in-vehicle authentication system constitute the in-vehicle authentication system as independent functional blocks. However, the configuration may be different from those in the above embodiments, and the configuration of the in-vehicle authentication system may be any configuration. The functional blocks of the in-vehicle authentication system may be any functional blocks, provided that the functions described in the above embodiments can be realized. The in-vehicle authentication system may be configured by any other combination of these functional blocks or by any block configuration.

The first to third embodiments have been described. A plurality of portions of these embodiments may be implemented in combination. Alternatively, one portion of these embodiments may be implemented. Alternatively, these embodiments may be implemented as a whole or partially in any combination.

Note that the above-described embodiments are essentially preferred examples, and are not intended to limit the scope of the present invention, the scope of applications of the present invention, and the scope of intended uses of the present invention. Various modifications may be made to the above-described embodiments as necessary.

### REFERENCE SIGNS LIST

10, 10b: in-vehicle authentication system; 20: attribute information; 100, 100a, 100b: vehicle communication apparatus; 101, 304: authentication part; 102, 305: determination part; 103: update part; 104, 307: storage part; 105, 308: reception part; 106, 309: transmission part; 107, 311: display part; 110, 320: key management part; 111a: control part; 200: vehicle; 201: in-vehicle network; 202: ECU; 250: CPU; 252: programs; 253, 621: ECU information; 254: communication device; 300, 300a: authentication management apparatus; 301: update data processing part; 108, 302: configuration data generation part; 109, 303: function correlation generation part; 306: table management part; 310: acceptance part; 400: vendor server apparatus; 511: header information; 512: ECU difference information; 513: update software; 521: configuration data difference; 522: function correlation difference; 610: configuration data table; 601: configuration data; 611: configuration data information; 620: ECU information table; 630: authentication error list; 631: authentication error table; 640: function correlation table; 650: update information; 651: ECU update information; 652: table update information; 801, 901: processor; 251, 802, 902: memory; 803, 903: auxiliary storage device; 804, 904: communication device; 805, 905: display; 906: input device; 907: input device; 809, 909: electronic circuit; 500: function display screen

1-11. (canceled)

12. An in-vehicle authentication system having a vehicle communication apparatus, the vehicle communication apparatus being provided in a vehicle equipped with a plurality of electronic control units and communicating with each electronic control unit of the plurality of electronic control units, the in-vehicle authentication system comprising:
processing circuitry to:
perform configuration authentication for authenticating validity of a configuration for each electronic control unit of the plurality of electronic control units, and register an electronic control unit that has failed the configuration authentication in an authentication error list,
determine an in-vehicle function that is available in the vehicle based on the authentication error list and a function correlation table which indicates correlation between an in-vehicle function which is a function provided in the vehicle and an electronic control unit that controls the in-vehicle function, and
display the in-vehicle function determined to be available in the vehicle on a display of the vehicle communication apparatus.

13. The in-vehicle authentication system according to claim 12,
wherein the plurality of electronic control units communicate with one another via an in-vehicle network, and
wherein the processing circuitry of the in-vehicle authentication system disconnects the electronic control unit registered in the authentication error list from the in-vehicle network.

14. The in-vehicle authentication system according to claim 12, further comprising
a memory to store a configuration data table composed of configuration data information in which each electronic control unit of the plurality of electronic control units is associated with configuration data generated from attribute information which indicates an attribute of each electronic control unit of the plurality of electronic control units,
wherein the processing circuitry of the in-vehicle authentication system acquires, from an electronic control unit of the plurality of electronic control units, attribute information which indicates an attribute of the electronic control unit, calculates a signature of the electronic control unit based on the attribute information, compares the signature with the configuration data included in the configuration data table, and when the signature matches the configuration data, determines that the configuration authentication of the electronic control unit is successful.

15. The in-vehicle authentication system according to claim 14, further comprising
an authentication management apparatus including the memory,
the authentication management apparatus further including
processing circuitry to, upon receiving unit change information which indicates a change related to an electronic control unit of the plurality of electronic control units, update the configuration data table based on the unit change information.

16. The in-vehicle authentication system according to claim 15,
wherein the unit change information includes the attribute information of the electronic control unit, and
wherein the processing circuitry of the authentication management apparatus updates the function correlation table based on the unit change information.

17. The in-vehicle authentication system according to claim 16,
wherein the processing circuitry of the authentication management apparatus generates update information including a configuration data difference which is a difference between the configuration data table before an update and after the update and a function correlation difference which is a difference between the function correlation table before an update and after the update, and transmits the update information to the vehicle communication apparatus.

18. The in-vehicle authentication system according to claim 14,
wherein upon receiving unit change information which indicates a change in an electronic control unit of the plurality of electronic control units, the processing circuitry of the in-vehicle authentication system updates the configuration data table based on the unit change information, and
updates the function correlation table based on the unit change information.

19. The in-vehicle authentication system according to claim 18, further comprising
an authentication management apparatus including the memory,
wherein the vehicle communication apparatus includes processing circuitry to collect, from each electronic control unit of the plurality of electronic control units, the attribute information of each electronic control unit, and transmit the collected attribute information to the authentication management apparatus, and
wherein the processing circuitry of the authentication management apparatus performs configuration authentication for authenticating validity of a configuration for each electronic control unit of the plurality of electronic control units, and registers an electronic control unit that has failed the configuration authentication in an authentication error list,
determines an in-vehicle function that is available in the vehicle based on the authentication error list and a function correlation table which indicates correlation between an in-vehicle function which is a function provided in the vehicle and an electronic control unit that controls the in-vehicle function,
updates, upon receiving unit change information which indicates a change in an electronic control unit of the plurality of electronic control units, the configuration data table based on the unit change information,
updates the function correlation table based on the unit change information,
transmits the authentication error list to the processing circuitry of the vehicle communication apparatus, and
transmits the in-vehicle function that is available in the vehicle as a determination result to the processing circuitry of the vehicle communication apparatus.

20. The in-vehicle authentication system according to claim 18,
wherein the processing circuitry of the vehicle communication apparatus performs configuration authentication for authenticating validity of a configuration for each electronic control unit of the plurality of electronic control units, and registers an electronic control unit that has failed the configuration authentication in an authentication error list,
determines an in-vehicle function that is available in the vehicle based on the authentication error list and a function correlation table which indicates correlation between an in-vehicle function which is a function provided in the vehicle and an electronic control unit that controls the in-vehicle function,
updates, upon receiving unit change information which indicates a change related to an electronic control unit of the plurality of electronic control units, the configuration data table based on the unit change information, and
displays the in-vehicle function determined to be available in the vehicle on the display of the vehicle communication apparatus.

21. A vehicle communication apparatus provided in a vehicle equipped with a plurality of electronic control units and communicating with each electronic control unit of the plurality of electronic control units, the vehicle communication apparatus comprising:
processing circuitry to:
collect, from each electronic control unit of the plurality of electronic control units, attribute information of each electronic control unit, and transmit the collected attribute information to an authentication management apparatus that determines whether an in-vehicle function which is a function provided in the vehicle is available or not by determining validity of a configuration of each electronic control unit, and
display the in-vehicle function determined to be available in the vehicle by the authentication management apparatus on a display.

22. The vehicle communication apparatus according to claim 21,
wherein the processing circuitry transmits the attribute information to the authentication management apparatus that performs, using the attribute information, configuration authentication for authenticating validity of a configuration for each electronic control unit of the plurality of electronic control units, registers an electronic control unit that has failed the configuration authentication in an authentication error list, and determines an in-vehicle function that is available in the vehicle based on the authentication error list and a function correlation table which indicates correlation between an in-vehicle function and an electronic control unit that controls the in-vehicle function.

23. An authentication management apparatus comprising:
processing circuitry to:
acquire, from a vehicle equipped with a plurality of electronic control units, attribute information which indicates an attribute of each electronic control unit of the plurality of electronic control units, and using the attribute information, perform configuration authentication for authenticating validity of a configuration for each electronic control unit of the plurality of electronic control units, and register an electronic control unit that has failed the configuration authentication in an authentication error list, and
determine an in-vehicle function that is available in the vehicle based on the authentication error list and a function correlation table which indicates correlation between an in-vehicle function which is a function provided in the vehicle and an electronic control unit that controls the in-vehicle function.

24. An in-vehicle authentication method for an in-vehicle authentication system having a vehicle communication apparatus, the vehicle communication apparatus being provided in a vehicle equipped with a plurality of electronic control units and communicating with each electronic control unit of the plurality of electronic control units, the in-vehicle authentication method comprising:
performing configuration authentication for authenticating validity of a configuration for each electronic control unit of the plurality of electronic control units, and registering an electronic control unit that has failed the configuration authentication in an authentication error list;
determining an in-vehicle function that is available in the vehicle based on the authentication error list and a function correlation table which indicates correlation between an in-vehicle function which is a function provided in the vehicle and an electronic control unit that controls the in-vehicle function; and
displaying the in-vehicle function determined to be available in the vehicle by the determination part on a display of the vehicle communication apparatus.

25. A non-transitory computer readable medium storing an in-vehicle authentication program for an in-vehicle authentication system having a vehicle communication apparatus, the vehicle communication apparatus being provided in a vehicle equipped with a plurality of electronic control units and communicating with each electronic control unit of the plurality of electronic control units, the in-vehicle authentication program causing a computer to execute:
an authentication process to perform configuration authentication for authenticating validity of a configuration for each electronic control unit of the plurality of electronic control units, and register an electronic control unit that has failed the configuration authentication in an authentication error list;
a determination process to determine an in-vehicle function that is available in the vehicle based on the authentication error list and a function correlation table which indicates correlation between an in-vehicle function which is a function provided in the vehicle and an electronic control unit that controls the in-vehicle function; and
a display process to display the in-vehicle function determined to be available in the vehicle by the determination process on a display of the vehicle communication apparatus.
